(19) United States
(12) Patent Application Publication
(10) Pub. No.: US 2003/0207227 A1
(43) Pub. Date: Nov. 6, 2003

(54) Systems and methods for treating patients

(75) Inventor: Amir Abolfathi, Menlo Park, CA (US)

Correspondence Address: Bao Tran, Align Technology, 881 Martin Avenue, Santa Clara, CA, 95050, US

(73) Assignee: ALIGN TECHNOLOGY, INC., Santa Clara, CA

(21) Appl. No.: 10/137,725

(22) Filed: May 2, 2002

(51) Int. Cl. A61C 3/00

(52) U.S. Cl. 433/24

(57) ABSTRACT

Systems and methods for treating a patient at a treatment provider's office include digitally scanning the patient at the treatment provider's office and generating at the treatment provider's office one or more appliances to treat the patient.

### CROSS-REFERENCES TO RELATED APPLICATIONS

This application is related to U.S. patent application Ser. No. 09/169,276, filed on Oct. 8, 1998, and entitled “Computer Automated Development of an Orthodontic Treatment Plan and Appliance,” which claims priority from PCT application PCT/US98/12681, filed on Jun. 19, 1998, and entitled “Method and System for Incrementally Moving Teeth” (attorney docket number 18563-000120), which claims priority from U.S. patent application Ser. No. 08/947,080, filed on Oct. 8, 1997, which claims priority from U.S. provisional application No. 60/050,342, filed on Jun. 20, 1997, all of which are incorporated by reference into this application.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The invention relates generally to the medical and dental fields.

Two-dimensional (2D) and three-dimensional (3D) digital image technology has recently been tapped as a tool to assist in medical, dental and orthodontic treatment. Many treatment providers use for example, digital image technology to study bones, soft tissues and dentitions of patients. U.S. patent application Ser. No. 09/169,276 describes the use of 2D and 3D image data in forming a digital model of a patient's dentition, including models of individual dentition components. That application also describes using the digital dentition models in developing an orthodontic treatment plan for the patient, as well as in creating one or more orthodontic appliances to implement the treatment plan.

Some of these orthodontic appliances are rigid, shell-like devices that fit over the patient's teeth, applying the forces necessary to move the teeth to prescribed final positions. Such an appliance can be produced by pressure forming a sheet of material around a positive mold. In general, the positive mold is a solid block manufactured from a resin-based material in a rapid prototyping process.

### SUMMARY

In one aspect, a method of treating a patient at a treatment provider's office includes digitally scanning the patient at the treatment provider's office; and generating at the treatment provider's office one or more appliances to treat the patient.

Implementations of the above aspect may include one or more of the following. The patient can be scanned using a scanner. The scanner can be any suitable scanner, for example, an MRI scanner or an X-ray machine. The method may include scanning the patient's masticatory system. The scanner may be an intra-oral scanner to scan the patient's teeth. The method includes separating each tooth from the scanned teeth. The method can manipulate and set each tooth in a desired tooth position. The method can generate an image of the teeth in its desired position and merge the image of the teeth in its desired position with the patient's image.

The method can allow tooth measurements. The method can include milling to each appliance from a polymeric material. The method can use thermal forming to each appliance by thermal forming a sheet polymer to form the appliance and preparing the appliance for usage.

The method can include cutting, trimming and polishing the appliances. The method can prepare the appliance, using a laser machine and a milling machine. The method can shell a negative and a positive of the appliance. The aligner can be shelled from a biocompatible resin. The methods can include thermal-setting the appliance; applying a thermal set material to form the appliance; and preparing the appliance for use.

In another aspect, an apparatus for treating a patient includes a scanner adapted to scan the patient and a fabrication machine coupled to the scanner to generate one or more appliances.

Implementations of the above aspect may include one or more of the following. The fabrication machine can mill the appliance from a block of polymeric material. The fabrication machine can be a thermal forming machine. The fabrication can be a trimming machine to receive and trim the appliances. The trimming machine can be a laser machine and a milling machine.

The fabrication machine can shell a positive and a negative version of an appliance. The fabrication machine can fabricate appliances by using a biocompatible resin. The fabrication machine can comprise a thermal setting machine. The fabrication machine can be a stereo-lithography apparatus (SLA).

The method can comprise a virtual health-care electronic commerce community, including: a network to communicate information relating to the community; one or more patients coupled to the network; one or more treatment providers coupled to the network; and a server coupled to the network, the server storing data for each patient and performing patient data visualization in response to a user request.

The treatment provider can view one or more of the following patient data visualization over the network: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view. The treatment providers can include both dentists and orthodontists.

The method can include providing access to one or more partners. The partners can include a financing partner. The partner can include a supplier and a delivery company.

The treatment providers can perform office management operations using the server. The management operations can include one or more of the following: patient scheduling, patient accounting, and claim processing. The patients and the treatment providers can access the server using browsers.

The computer-implemented methods can perform dental-related electronic commerce, comprising: transmitting teeth data associated a patient from a dental server to a treatment provider computer over the Internet upon an authorized request; displaying a three-dimensional computer model of the teeth at the treatment provider computer using a browser; allowing the treatment provider to manipulate the three-dimensional computer model of the teeth using the browser; transmitting the computer model from the treatment provider computer to the server; and generating an appliance to treat the patient based on the computer model of the teeth.

The computer implemented methods can provide financing options for the patient using one or more financing partners. The methods can offer an on-line shop geared to the patient's dental requirements. The method can provide office management utilities for the treatment provider.

The office management utilities can include one or more of the following: patient scheduling, patient accounting, and claim processing. The method can allow a treatment provider to manipulate the three-dimensional computer model of the teeth using browser further comprises displaying a plurality of dental views.

The dental views include one or more of the following: a right buccal view, a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view.

The method can allow a treatment provider to manipulate the three-dimensional computer model of the teeth using the browser further comprises clicking on a tooth to adjust its position. The method displaying x, y and z axis can allow the treatment provider to adjust the position of the tooth. The method can provide supplemental services to the patient, for example teeth whitening services.

### BRIEF DESCRIPTION OF THE DRAWINGS

FIG. 1A is a diagram of an exemplary system for treating a patient at a professional service provider or treatment provider's office.

FIG. 1B is a flowchart illustrating an exemplary process for treating patient at the professional's office.

FIG. 1C is a flowchart illustrating an exemplary process for treating the patient's teeth at the professional's office.

FIG. 1D shows an exemplary system supporting patient treatment using the Internet.

FIG. 2 is a diagram of a server to support electronic commerce with the professional service provider's office.

FIG. 3 is a diagram of a web site on the server of FIG. 2.

FIG. 4 is a flowchart of a process for selecting dental services from a patient's perspective.

FIG. 5 is a flowchart of a first process for providing dental services from a treatment provider's perspective.

FIG. 6 is a flowchart of a second process for providing dental services from a treatment provider's perspective.

FIG. 7 is a flowchart of a process to render 3D views of a patient's teeth on a browser.

FIG. 8 is an exemplary output of the process of FIG. 7 using the browser.

FIG. 9 is a diagram of a system for manufacturing appliances.

FIG. 10 is a diagram illustrating a computer system to support the fabrication of appliances.

### DESCRIPTION

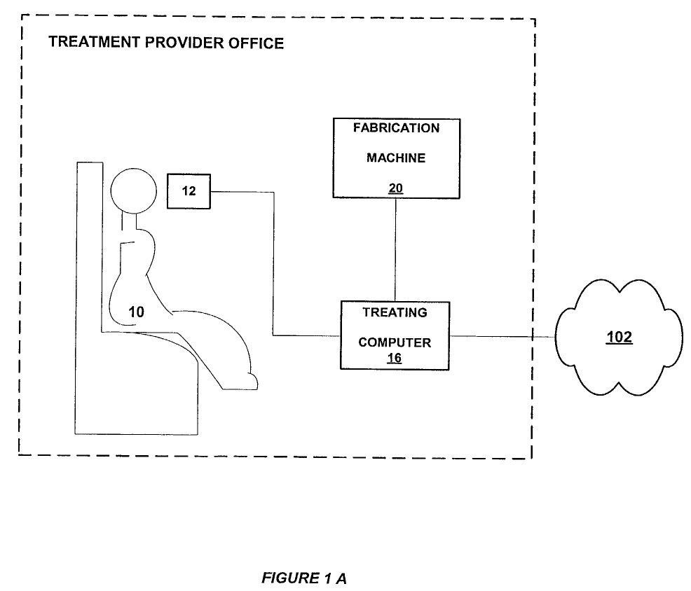

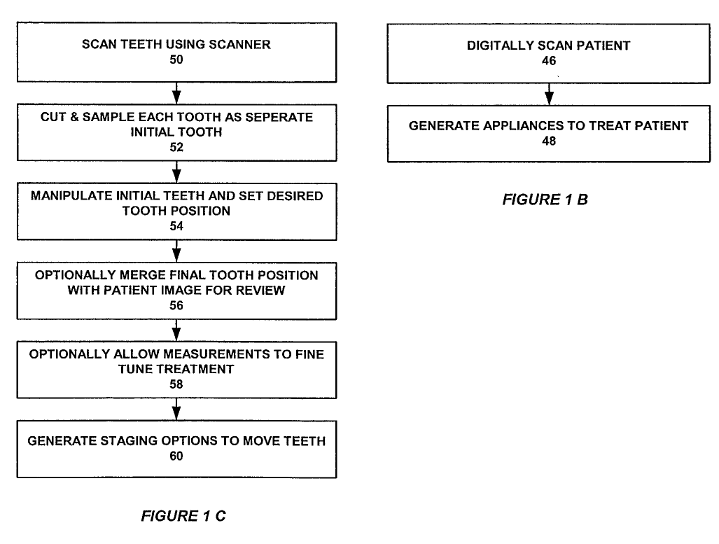

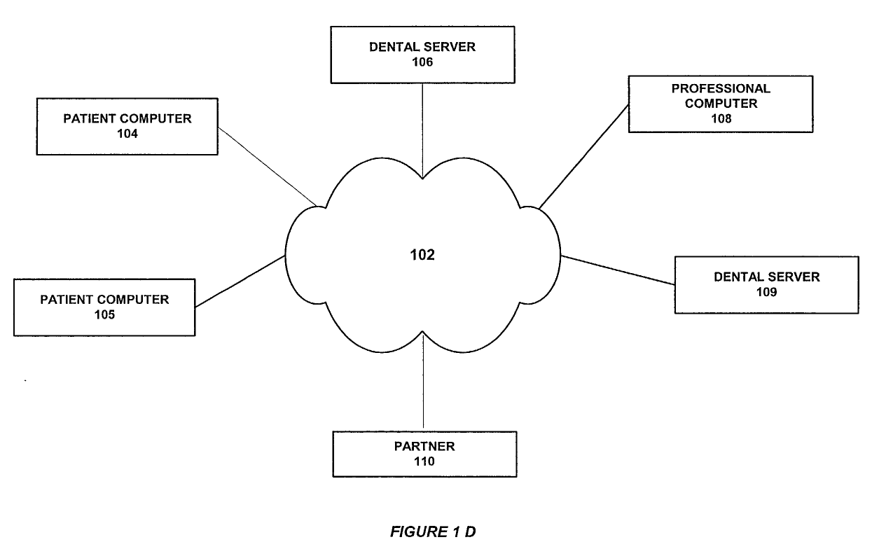

FIG. 1A shows an exemplary system for treating a patient at a professional service provider or treatment provider's office. A scanner 12 is used to scan a patient 10. The scanner can be an MRI scanner, an X-Ray machine, or an intra-oral scanner, for example. In applications that treat the masticatory system of the patient 10, the scanner 12 can scan the patient's teeth, soft issue, or both.

In the embodiment where the scanner 12 is an intra-oral scanner, masticatory data is uploaded to a treating computer 16 that performs, among others, generating a computer representation of the masticatory system of the patient; and determining an occlusion from the computer representation of the masticatory system. The treating computer 16 drives a fabrication machine 20 to generate one or more appliances to treat the patient's teeth in accordance with the determined occlusion. The treating computer 16 is also connected to a wide area network such as the Internet 102 to access ancillary services and information, among others.

The system of FIG. 1A allows a professional user (such as an orthodontist or a dentist, among others), to diagnose, prescribe the treatment, and fabricate the appliances or “aligners” at the patient chair side. The scanner 12 generates 2D or 3D volumetric data set of the patients for the arches or other masticatory portions of the patient. The scanned data can then be processed by the computer 16 using diagnostic and/or treatment software tool to cut the individual tooth and identify them as separate 3D objects such as tooth objects. Once each digital tooth object has been cut, the professional user or a suitable operator can then move and manipulate the tooth objects and set a desired tooth position using the software on the computer 16. In one implementation, the software can superimpose the frontal view of the final desired arch form on a 2D or 3D frontal digital image of the patient to allow the treatment provider to review and discuss the proposed treatment with the patient 10. In another embodiment, the software can process the scanned data and provide the user/operator with useful data and orthodontic measurements (e.g. arch width, arch length, tooth size, angulations) to assist the operator and or patient in fine tuning the treatment plan. The computer can then provide the operator with options in staging the treatment from one stage to another stage, or it can completely generate all stages ranging from the initial to final desired stage. The staging can be done automatically by (1) data-mining existing cases currently in a treatment database and identifying similar cases or (2) providing the operator with several feasible options using pattern recognition. Once the staging phase of the treatment has been completed, the data can then be transferred to the fabrication machine 20 to fabricate appliances. In one embodiment, the appliances can be aligners such as those described in U.S. Pat. No. 1 6,318,994 entitled “Tooth path treatment plan”, U.S. Pat. No. 6,309,215 entitled “Attachment devices and method for a dental appliance”; U.S. Pat. No. 6,299,440 entitled “System and method for producing tooth movement”; U.S. Pat. No. 6,227,851 entitled “Manipulable dental model system for fabrication of a dental appliance”; U.S. Pat. No. 6,227,850 entitled “Teeth viewing system”; U.S. Pat. No. 6,217,325 entitled “Method and system for incrementally moving teeth”; U.S. Pat. No. 6,210,162 entitled “Creating a positive mold of a patient's dentition for use in forming an orthodontic appliance”; and U.S. Pat. No. 5,975,893 entitled “Method and system for incrementally moving teeth”, the contents of which are hereby incorporated by reference. The treatment provider can then dispense these appliances at the patient chair side.

The fabrication machine 20 for fabricating aligners can employ the following exemplary technologies/methods:

1—Milling the aligner out of block of polymeric material

2—Thermal forming; 1) fabricate a prototype of the arch, 2) thermal form a sheet of polymer over it, and 3) cut, trim & polish it using laser and/or milling machine

3—Using shelling technique to rapid prototype (SLA) the aligner out of biocompatible resin

4—Thermal set; 1) fabricate a prototype of the arch, 2) apply thermal set material over it, and 3) once the material set, cut, trim and polish it using laser and/or milling machine.

FIG. 1B shows one embodiment for treating the patient at the professional's office. The process of FIG. 1B first digitally scans the patient at the treatment provider's office (46) and generates at the treatment provider's office one or more appliances to treat the patient (48).

FIG. 1C shows another embodiment for treating the patient's teeth at the doctor's office or treatment provider's office. First, the scanner 12 can acquire images of the inner arch, determine the occlusion (50), and based on that the computer 16 separates each tooth object for both the upper and lower arch (52). At that point the doctor could use software to move the tooth objects so that the final position of the occlusion satisfies the desired prescription of the doctor (54). Optionally, the system can merge the final position of the tooth objects with a patient image for preview purposes (56). As another option, the system allows the user to measure teeth data for treatment planning purposes (58). The computer 16 then generates stages required to treat the teeth (60). Once that is done the computer 16 drives the fabrication machine 20 to generate the aligners. Alternatively, the computer system 16 can send data over the wide area network 102 to a remote system that is capable of fabricating the aligner either to thermal forming means or directly to a 3-D printer that could shell the aligner or milling system that could fabricate the aligners. Alternatively, the system of FIGS. 1A-1B can generate indirect bonding templates and retainers.

Referring now to FIG. 1D, an environment supporting a dental system 100 is shown. The system 100 communicates over a network 102 that can be a local area network or a wide area network such as the Internet.

One or more client computers 104-105 can be connected to the network 102. In one embodiment where the network 102 is the Internet, the client computers execute a suitable browser such as Navigator from Netscape, Inc. and Internet Explorer from Microsoft Corp. By clicking on the highlighted text (or specific graphic image), the user can jump from the current web page to a new web page address associated with the link—with the new page displayed on the screen. In this manner, the user can “surf the web” by clicking on an almost endless succession of links going to page after page all following a common thread as defined by the text or graphic component of the link label.

Through the network 102, the client computers 104-105 can access a dental server 106. The dental server 106 serves a web site, a portal, a “vortal” (vertical portal), or a content site for providing dental related information to interested parties such as dental patients, dentists, orthodontists, and others. When sensitive information is communicated through the dental server 106, such information is securely encrypted using Secure Sockets Layer (SSL) technology throughout the transaction. The server 106 can be a stand-alone computer or can be a server farm that can distribute processing and communications activity across a computer network so that no single device is overwhelmed. During load balancing, if one server is swamped with requests, excess requests are forwarded to another server with more capacity.

The network 102 connects the dental server 106 to one or more treatment provider workstations 108-109. The workstations 108-109 allow treatment providers access to a plethora of services provided by the dental server 106 such as patient treatment and office management, among others. The dental server 106 stores information associated with patient history on-line in a secure manner. The server 106 also allows the treatment provider to have a comprehensive view of the patient's treatment history at any time using a suitable browser, eliminating the need to pull treatment files or charts or to look for misfiled or lost charts. The dental server 106 also provides treatment providers with tools to analyze patient data, for example, tools to reconstruct a 3D model of the teeth. For example, using the browser, the treatment provider can request the server 106 to animate the progress of the treatment plan. When the treatment provider arrives at a prescription or other final designation, the treatment prescription is used to automatically generate appliances, as described in more details below. Further, in addition to aiding professionals in treating patients, the treatment provider can perform office management, purchasing and other logistical operations using the browser and the dental server 106.

In addition to communicating with patients and treatment providers, the dental server 106 can communicate with one or more partners 110 using the network 102. The partners 110 can be product suppliers, service providers, or any suitable commercial entities.

One partner 110 can be a financing partner that offers customers with one or more electronic financing options. In one implementation, the financing partner can be a credit card processing company. The credit card processing company can accept a customer's existing credit card or can issue the customer with a new credit card. Further, the credit card can be issued under the name of a third-party bank, the name of the credit card processing company, or the name of the site supported by the dental server 106 under a co-branding arrangement.

The customer enters the sensitive data such as credit card number, shipping address, among others, onto a purchase form. The credit data is then submitted, collected and passed securely through the dental server 106. This data can be processed in real time or can be collected by mail or telephone and then entered by an operator. A processor at the credit card processing company then verifies that the credit card number is valid and is not stolen, among other anti-fraud measures. If the credit card information is valid, the purchase price will be reserved from the issuing bank of the consumer's credit card and allocated to the account associated with the server 106. Periodically, the credit card processor settles all accounts; it is at this time that all monies move. Funds reserved are transmitted from the issuing bank of the cardholder's credit card to the account of the server 106. Also, discount fees are paid from these funds, as they are moving.

Alternatively, the financing partner can debit from the customer's checking account over the Internet. One such check debiting services is the MerchanTrust™ Paperless Checks™ Services, available from Merchant Commerce, Inc. These services provide customers with the convenience of making online purchases by checking account debits, with no manual data entry required of a merchant. In this embodiment, a customer fills in a form at the site with bank information printed at the bottom of his or her personal check. The information is processed as an Electronic Funds Transfer (EFT) to the customer's account using the Automated Clearinghouse (ACH) payment system.

Yet another possible partner 110 is a dental supply retailer providing an on-line shop on the web site to retail dental products to the customers and treatment providers. The retailer can be a co-branding partner that uses the brand name linked or suitably associated with the web site of the server 106 such that users of the server 106 would not know that the on-line shop is actually operated by a third party. The retailer can offer dental products for brushing, flossing, and cleaning of dental implants and bridges. Other dental products include anti-plaque rinse and plaque-fighting toothpaste. The retailer can also sell other health-care-related products such as prescription drugs; non prescription drugs; personal care; beauty and spa; vitamins, herbs and nutrition; and medical supplies. Additionally, the retailer can serve the needs of the treatment providers by offering products such as brackets, buccal tubes, bands, archwire products, bonding adhesives, hand instruments, systems, supplies and equipment.

Yet another partner 110 can be a shipping partner. The shipping partner delivers dental supply or goods received from a multiplicity of producers and manufacturers for ultimate distribution to each customer. The facilities for warehousing and introduction of goods into a transportation stream for redistribution are the so-called cross docking facilities. The supply or good flows in bulk from a producer or a manufacturer to one or more cross docking facilities owned by either the shipping partner or the operator of the server 106. The items are then be broken into smaller unit sizes and distributed to the customers.

The above list of partners lists only exemplary partners and is not an exhaustive list. Other possible partners include value-added service providers such as third party software providers who provide plug-in viewing and diagnostic enhancements that can be used by the professionals.

The server 106 can perform dynamic targeting and information gathering. The users provide demographic information when they register for our service. The server 106 can track our users'behavior the entire time they are online. As a result, the server 106 can deliver targeted advertisements and measure their effectiveness. For example, users can receive ads from a brokerage firm when they are viewing sites containing stock quotes or financial news, or receive promotions from a bookseller when browsing sites containing book reviews. As such, the dental server 106 can provide a prominent and sustained advertising medium to the community. In contrast to most portal and content sites which display advertising, the site remains with users the entire time they are online. Once users are logged on, the site remains in'full view throughout the session, including when they are waiting for pages to download, navigating the Internet and even engaging in non-browsing activities such as sending or receiving e-mail. The constant visibility of the site allows advertisements to be displayed for a specified period of time.

In combination, the dental server 106 forms a hub that links dental clients using client computers 104-105, treatment providers using workstations 108-109, and partners 110 into a living electronic commerce (e-commerce) community.

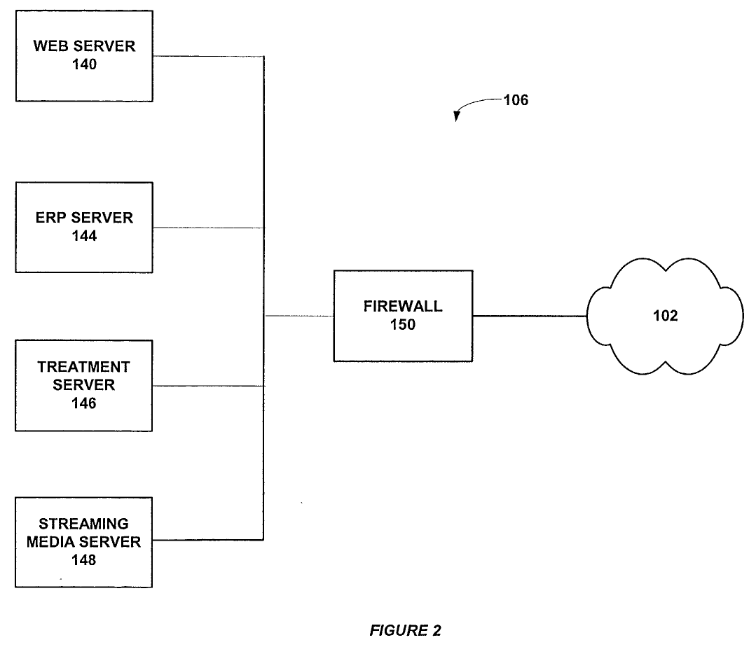

FIG. 2 shows an embodiment of the server 106. The server 106 includes a web server 140, a patient information server 142, a resource planning (RP) server 144 and a streaming server 146. In one embodiment, the RP server 144 runs Microsoft SQL server and provides information relating to a doctor or a patient such as address and history. When a patient's case or static snapshots of the case is needed, the data is pulled from the patient information server 142. When media data such as video needs to be streamed to a requesting client, the streaming server 146 can send the stream. In one implementation, the streaming data is stored in QuickTime format on a Linux-based server running the QuickTime server software.

The servers can be clustered. In one embodiment using Microsoft's Cluster Server, cluster-enabled applications such as Microsoft's SQL Server and Exchange. With Cluster Server, two servers can run applications at the same time. When one server fails, the remaining server handles its application as well as the failed server's applications. Next, the remaining server adopts the IP address of the failed server and mounts one or more data drives that the two systems share. The remaining server is rebooted and applications such as SQL Server can be started and initialized on this server. Persistent clients can re-attach to the server and continue to operate.

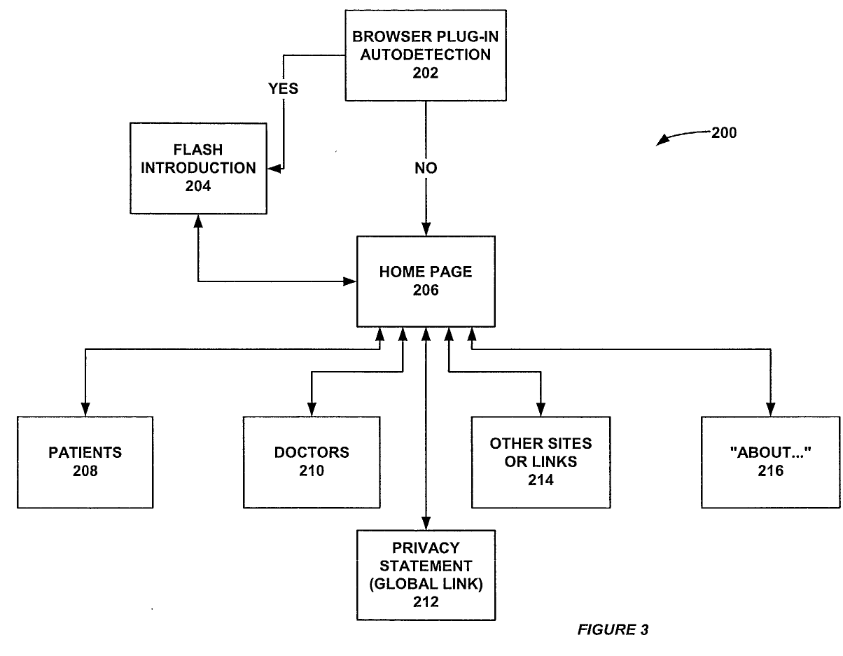

Referring now to FIG. 3, a diagram 200 shows various major functions supported by the dental server 106. First, the process 200 performs an automatic detection for the existence of a browser welcome plug-in (202). If the welcome plug-in exists, an introductory animation (flash) is shown (204). From step 204 or 206, the process 200 shows a home page (208) with one or more links. A link is created by having a word in a text field (or a graphic image on a web page) linked to the location of another web page, via a string of information setting forth the new web page address presented in hypertext transfer protocol (HTTP), among others.

The user can navigate the home page to join a particular site from a constellation of related sites. For instance, the user can navigate to a patient's site (208), a doctor's site (210), a privacy statement site (212), one or more additional sites (214), and an about site (216), among others. The additional sites can be an on-line shopping store that is co-branded with the web site hosted by the server 106, or the on-line shopping store can be directly affiliated with a third party such as planet-rx.com, among others. The additional sites can also be third party value-added providers of products and/or services.

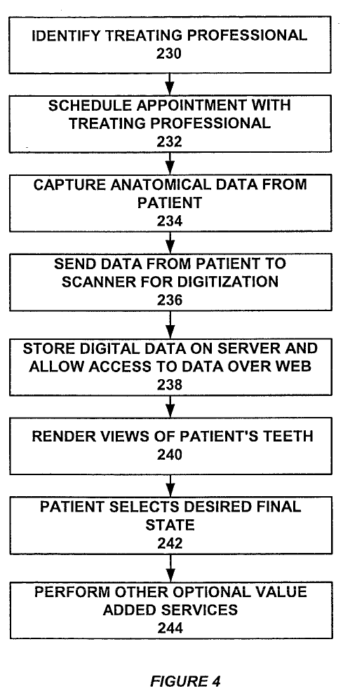

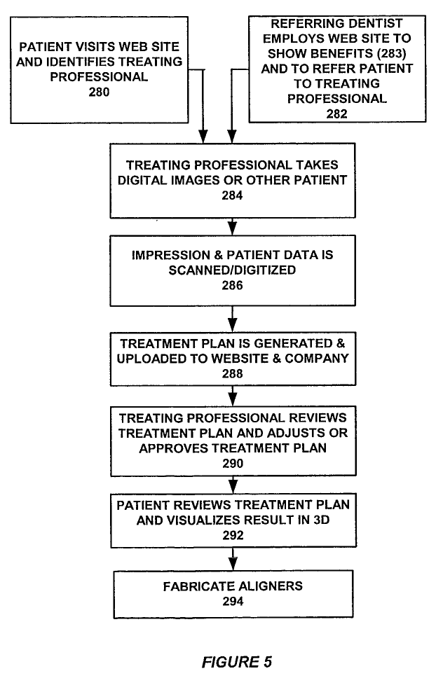

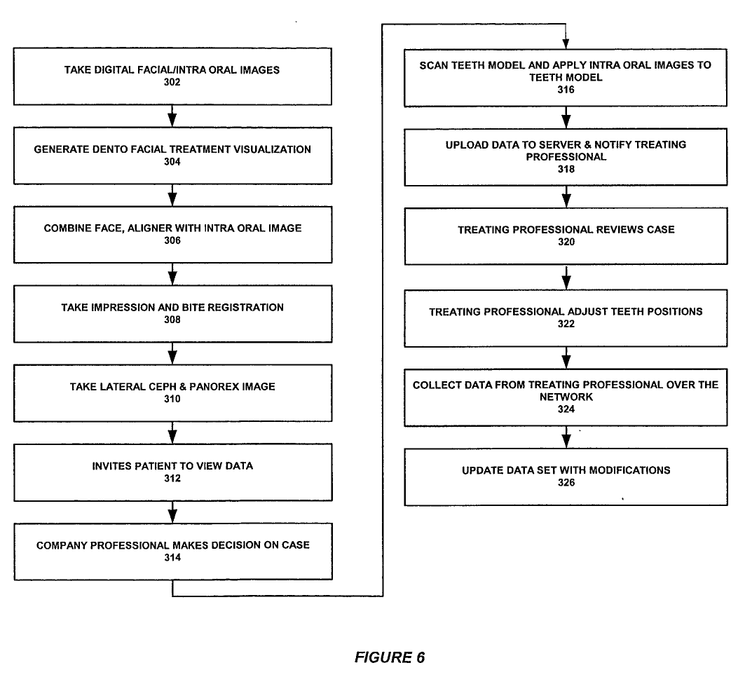

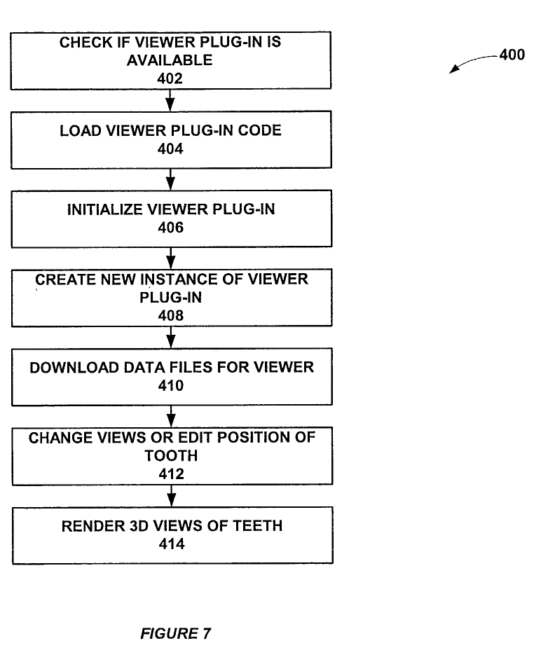

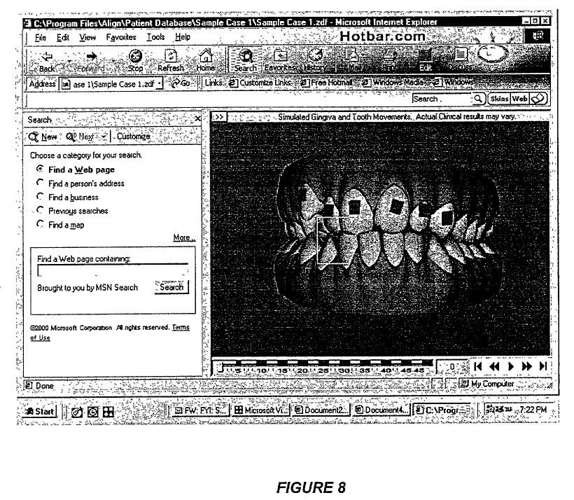

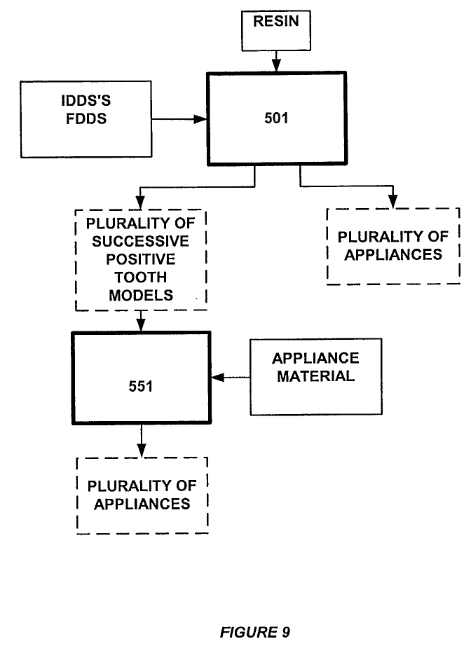

FIG. 4 illustrates an exemplary usage of the system of FIG. 1 from a patient's perspective. First, a prospective client using a client computer 104 visits the web site on the dental server 106 and identifies a treatment provider meeting one or more criteria, for example a professional whose location is closest to his or her home address (230). Next, the patient schedules an appointment with the treatment provider (232). At the meeting, an assistant captures various anatomical data from the patient by taking digital photographs of the face and teeth, taking x-rays of the front, back, side, and top/bottom of the patient, taking one or more impressions, among others (234). Next, this information is entered into a form on the server 106 (236). The data is then digitized, stored on the server 106, and made available to the treatment providers and the patient over the Internet (238). Next, the server 106 and one or more orthodontic treating persons process the patient data and render the patient's teeth in a plurality of alternative final states (240). Based on the choices, the patient selects a desired final state (242).

In addition to performing orthodontic operations, the server 106 can also perform other value-added services. For example, processes executed by the server 106 can simulate the color of the patient's enamel and show the color of the teeth before and after bleaching (244). Further, processes on the server 106 can simulate the color of the patient's silver fillings (amalgram) and show the teeth after cosmetic work to cover the amalgam (246). After visualizing the effects of the operations, comparing the before and after operations, and reviewing guideline pricing for the orthodontic operation as well as add-ons such as bleaching (248), the patient makes a decision (250).

Once the patient has accepted a particular treatment selection, the server 106 offers the patient with one or more financing options from one of its financial partners (256). Additionally, the server 106 can guide the patient to an on-line shopping store to purchase products relating to his or her dental health (258). For example, the patient can buy cleaning supplies, brushes, and flossing supply at a price competitive to his or her traditional stores. Moreover, the products can be delivered to the patient using one or more delivery partners at a convenient time (260).

FIG. 4 illustrates an exemplary usage of the system of FIG. 1 from a treatment provider's perspective. A prospective patient uses a client computer 104 and visits the web site on the dental server 106 (280). The client identifies a treatment provider and schedules an appointment with the treatment provider (281). Alternatively, a referring dentist can refer the client to the treating orthodontist (282). The referring dentist can visit the web site on the dental server 106 and uses one or more dental esthetic tools to show patients the potential benefits of anterior and posterior esthetic restorations and, if the patient is interested, refers the patient to the treatment provider (283).

During an initial examination, the treatment provider or an assistant takes a set of digital facial and intraoral images which is uploaded to a secure, collaborative workspace on the dental server 106 (284). The workspace is shared with the referring dentist.

Next, the treatment provider generates a dentofacial treatment visualization showing the patient's face and smile before and after treatment (286). The treatment provider can also combine the patient's face and an aligner into the intraoral image to show how the inconspicuous the appliance will be (288).

Once the patient requests treatment, the treatment provider takes impressions and a bite registration and sends the information to the company (290). The treatment provider also takes a lateral ceph and a panorex and uploads them and a treating prescription to the workspace (292). The professional's assistant creates a separate workspace for the patient, uploads selected “before and after” images into it, and invites the patient to review the images (294).

At the company, another professional reviews the records and decides to accept or decline the case (296). The models are then scanned, and the intraoral images are retrieved and used to texture-map enamel and gingiva (298). The data is then sent to the workspace and the treatment provider is notified (300).

In one embodiment, the tooth models may be posted on a hypertext transfer protocol (http) web site for limited access by the corresponding patients and treating clinicians. Since realistic models have a large volume of data, the storage and transmission of the models can be expensive and time consuming. To reduce transmission problems arising from the large size of the 3D model, in one embodiment, data associated with the model is compressed. The compression is done by modeling the teeth meshes as a curve network before transmission to the treatment provider. Once the curve network is received, the 3D model is reconstructed from the curve network for the treatment provider to analyze. More information on the compression is disclosed in a co-pending application having U.S. Ser. No. 09/576721, entitled, “EFFICIENT DATA REPRESENTATION OF TEETH MODEL”, and filed by ELENA PAVLOVSKAIA and HUAFENG WEN on Feb. 17, 2000, the contents of which are hereby incorporated.

The treatment provider can, at his or her convenience, check the setup, and review the information sent in step 300 (302). The treatment providers can use a variety of tools to interpret patient information. For example, the treatment provider can retrieve and analyze patient information through a reconstructed 3D model of the patient's teeth and other anatomical structures. The professional can view animations showing the progress of the treatment plan to help the treating physician visualize the pace of treatment. Using these tools, the treatment provider can easily and quickly view and/or edit the treatment plan.

If necessary, the treatment provider can adjust one or more teeth positions at various intermediate stages of treatment (302). A variety of diagnostic decision-support capabilities such as automated teeth collision detection can be used to aid the treatment provider in adjusting the teeth positions.

When the treatment provider arrives at a prescription or other final designation, the treatment information is automatically collected by the system over the Internet, thus eliminating the cost and delay associated with the traditional physical shipping of patient information (304). These modifications are then retrofitted onto the dataset used to generate the aligners (306).

FIG. 3 shows a process 400 associated with a viewer that allows the treatment provider to visualize the patient's teeth over the network 102 such as the Internet. In one embodiment, during start-up, a browser checks for a viewer plug-in module embodying the process 400 in a “plugins” subdirectory (Windows) or Plug-ins folder (Mac OS) in the same folder or directory as the browser (402). If the viewer plug-in module is available, the browser looks for a MIME type and extension info from the version resource. Through a TYPE attribute, the browser knows the MIME type and can load a registered plug-in first and, if there are no matches for the MIME type, the browser looks for a helper application.

Once the viewer plug-in is identified, the browser loads the viewer plug-in code into memory (404); initializes the viewer plug-in (406); and creates a new instance of the viewer plug-in (408). When the professional leaves the site or closes the window, the viewer plug-in instance is deleted. When the last instance of the viewer plug-in is deleted, the plug-in code is unloaded from memory.

Next, data files are downloaded to the viewer plug-in (410). In one implementation, the viewer plug-in downloads a data file from the dental server 102 using a suitable protocol such as a file transfer protocol (FTP). The viewer plug-in uses the downloaded file to present the treatment plan graphically to the clinician. The viewer plug-in also can be used by the treatment plan designer at the host site to view images of a patient's teeth. FIG. 4 shows an exemplary user interface for the viewer plug-in of FIG. 3. The professional can change views, select a particular tooth and change its position as desired (412).

3-D images of various orthodontic views can then be rendered after each instruction from the treatment provider is received (414). In this process, an origin point, or “look from” point associated with a camera view is generated. Next, a “look at” point or a focus point associated with the camera view is determined. In this system, the line from LookFromPoint to LookAtPoint defines the direction the camera is shooting at. Additionally, a camera Z vector, or up vector, is determined.

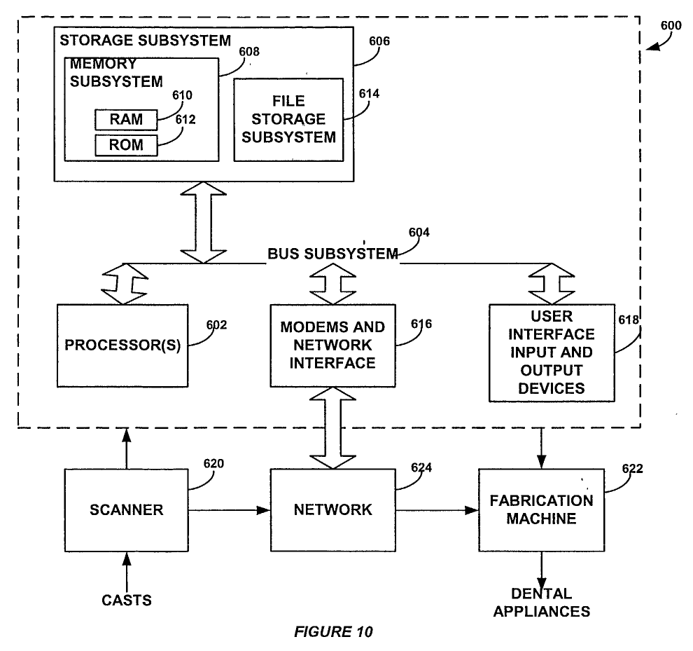

Once the intermediate and final data sets have been created, the appliances may be fabricated as illustrated in FIG. 10. Common fabrication methods employ a rapid prototyping device 201 such as a stereolithography machine. A particularly suitable rapid prototyping machine is Model SLA-250/50 available from 3D System, Valencia, Calif. The rapid prototyping machine 201 selectively hardens a liquid or other non-hardened resin into a three-dimensional structure which can be separated from the remaining non-hardened resin, washed, and used either directly as the appliance or indirectly as a mold for producing the appliance. The prototyping machine 201 receives the individual digital data sets and produces one structure corresponding to each of the desired appliances. Generally, because the rapid prototyping machine 201 may utilize a resin having non-optimum mechanical properties and which may not be generally acceptable for patient use, the prototyping machine typically is used to produce molds which are, in effect, positive tooth models of each successive stage of the treatment. After the positive models are prepared, a conventional pressure or vacuum molding machine 251 is used to produce the appliances from a more suitable material, such as 0.03 inch thermal forming dental material, available from Tru-Tain Plastics, Rochester, Minn. 55902. Suitable pressure molding equipment is available under the trade name BIOSTAR from Great Lakes Orthodontics, Ltd., Tonawanda, N.Y. 14150. The molding machine 251 produces each of the appliances directly from the positive tooth model and the desired material. Suitable vacuum molding machines are available from Raintree Essix, Inc.

After production, the appliances can be supplied to the treatment provider all at one time. The appliances are marked in some manner, typically by sequential numbering directly on the appliances or on tags, pouches; or other items which are affixed to or which enclose each appliance, to indicate their order of use. Optionally, written instructions may accompany, the system which set forth that the patient is to wear the individual appliances in the order marked on the appliances or elsewhere in the packaging. Use of the appliances in such a manner will reposition the patient's teeth progressively toward the final tooth arrangement.

Because a patient's teeth may respond differently than originally expected, the treating clinician may wish to evaluate the patient's progress during the course of treatment. The system can also do this automatically, starting from the newly-measured in-course dentition. If the patient's teeth do not progress as planned, the clinician can revise the treatment plan as necessary to bring the patient's treatment back on course or to design an alternative treatment plan. The clinician may provide comments, oral or written, for use in revising the treatment plan. The clinician also can form another set of plaster castings of the patient's teeth for digital imaging and manipulation. The clinician may wish to limit initial aligner production to only a few aligners, delaying production on subsequent aligners until the patient's progress has been evaluated.

The invention has been described in terms of particular embodiments. Although teeth treatment is discussed, the invention can be used to generate prosthesis for patients, among others. Other embodiments are within the scope of the following claims.

What is claimed is

1. A method of treating a patient at a treatment provider's office, comprising:
digitally scanning the patient at the treatment provider's office; and
generating at the treatment provider's office one or more appliances to treat the patient.

2. The method of claim 1, further comprising scanning the patient with a scanner.

3. The method of claim 2, wherein the scanner further comprises one of the following: an MRI scanner, and an X-ray machine.

4. The method of claim 1, further comprising scanning the patient's masticatory system.

5. The method of claim 1, further comprising scanning the patient's teeth.

6. The method of claim 5, wherein scanning the teeth comprises using an intra-oral scanner.

7. The method of claim 1, further comprising moving the scanned teeth into a desired teeth position.

8. The method of claim 1, further comprising separating each tooth from the scanned teeth.

9. The method of claim 1, further comprising manipulating and setting each tooth in a desired tooth position.

10. The method of claim 1, further comprising generating one or more staging options to move the teeth.

11. The method of claim 1, further comprising:
generating an image of the teeth in its desired position; and
merging the image of the teeth in its desired position with a patient image.

12. The method of claim 1, further comprising allowing measurements to each tooth.

13. The method of claim 1, further comprising milling each appliance from a polymeric material.

14. The method of claim 1, further comprising thermal forming each appliance.

15. The method of claim 1, further comprising:
thermal forming a sheet polymer to form the appliance; and
preparing the appliance for use.

16. The method of claim 1, further comprising cutting, trimming and polishing the appliance.

17. The method of claim 1, wherein the appliance is prepared using a laser machine.

18. The method of claim 1, wherein the appliance is prepared using a milling machine.

19. The method of claim 1, further comprising shelling a negative of the appliance.

20. The method of claim 1, further comprising shelling a positive of the appliance.

21. The method of claim 1, further comprising shelling the aligner from a bio-compatible-resin.

22. The method of claim 1, further comprising thermal setting the appliance.

23. The method of claim 1, further comprising:
applying a thermal set material to form the appliance; and preparing the appliance for use.

24. An apparatus for treating a patient at a treatment provider's office, comprising:
a scanner adapted to scan the patient, the scanner located at the treatment provider's office; and
a fabrication machine coupled to the scanner and located at the treatment provider's office, the fabrication machine generating one or more appliances to treat the patient.

25. The apparatus of claim 24, wherein the fabrication machine mills the appliance from a block of polymeric material.

26. The apparatus of claim 24, wherein the fabrication machine is a thermal forming machine.

27. The apparatus of claim 24, further comprising a trimming machine to receive and trim the appliances.

28. The apparatus of claim 24, wherein the trimming machine is a laser machine.

29. The apparatus of claim 24, wherein the trimming machine is a milling machine.

30. The apparatus of claim 24, wherein the fabrication machine shells a positive version of an appliance.

31. The apparatus of claim 24, wherein the fabrication machine shells a negative version of an appliance.

32. The apparatus of claim 24, wherein the fabrication machine fabricates appliances using a bio-compatible resin.

33. The apparatus of claim 24, wherein the fabrication machine comprises a thermal setting machine.

34. The apparatus of claim 24, further comprising a virtual health-care electronic commerce community, including:
a network to communicate information relating to the community;
one or more patient computers coupled to the network;
one or more treatment provider computers coupled to the network; and
a server coupled to the network, the server storing data for each patient and performing patient data visualization in response to a user request.

35. The apparatus of claim 34, wherein the treatment provider views one or more of the following patient data visualization over the network: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view.
